(19) United States
(12) Patent Application Publication
(10) Pub. No.: US 2007/0127640 A1
(43) Pub. Date: Jun. 7, 2007

(54) SYSTEM, METHOD AND COMPUTER PROGRAM FOR SENDING AN EMAIL MESSAGE FROM A MOBILE COMMUNICATION DEVICE BASED ON VOICE INPUT

(75) Inventor: Benoit Brunel, Saint-Charles-sur-Richelieu (CA)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: 9160-8083 QUEBEC INC., Boucherville (CA)

(21) Appl. No.: 11/562,646

(22) Filed: Nov. 22, 2006

(30) Foreign Application Priority Data
Nov. 24, 2005 (CA) 2,527,813

(51) Int. Cl. H04M 11/00

(52) U.S. Cl. 379/88.13

(57) ABSTRACT

A method, system and computer program (10) areis provided for enabling an email message to be sent from a communication device (22) to a remote device by operation of an intermediary server computer based on voice input from a voice input the communication device (28). The intermediary server computer (10) provides means for the user of the communication device (22) to selectively determine by voice activation the recipient address of the email sent by the system. Voice interaction between an address book established on the intermediary server computer for a user and the authorized user occurs by operation of a matching utility. The intermediary server computer (10) is operable to transform the voice input into email content and include this email content in the email by either (1) attaching the voice input to the email, or (2) converting the voice input to text by operation of a speech to text engine. In another aspect of the present invention, the intermediary server computer is linked to means for training a speech to text engine for converting the voice input from a particular user to binary text.

### FIELD OF INVENTION

This invention relates generally to communication systems, methods and computer programs. This invention relates more particularly to communications systems, methods and computer program enabling email communications via a communication device.

### BACKGROUND OF INVENTION

U.S. Pat. No. 6,507,643 ('643) discloses a system, method and computer program that relates to a voice-to-electronic mail system integrated with a voicemail system in which upon a user receiving a voicemail on the voicemail system, the voice-to-electronic mail system is operable to convert the voicemail into a text message, which is emailed to the user. '643 is not concerned with enabling the user to send email messages to a remote computer by operation of the “voice-to-electronic mail system”.

U.S. Pat. No. 6,732,151 discloses a method for forwarding voice messages of a user to the email account of the same user. This invention enables voice messages to be obtained from a voicemail system for encoding such messages as a streaming media file sent as an email attachment to the user, where passwords are associated with retrieval of voice messages from the voicemail system.

U.S. Pat. No. 6,574,599 ('599) discloses a method for enabling communication between a telephone and a remote communication device through a unified messaging system. U.S. Pat. No. 6,477,240 ('240) is a related patent ('599, and '240 being referred to as the “Microsoft Patents”). The Microsoft Patents describe: a user interacting with a system that includes an address book, via a telephone; the address book is responsive to voice commands from the user via the telephone, including for sending an email to a remote computer. The Microsoft Patents do not disclose the method or computer program involved in enabling voice interaction with an electronic address book in a reliable manner.

Accordingly, what is needed is a system and method for enabling an email message to be sent from a communication device to a remote device by operation of an intermediary server computer based on voice input from the communication device. The intermediary server computer provides means for the user of the communication device to selectively determine by voice activation the recipient address of the email sent by the system.

### BRIEF DESCRIPTION OF THE DRAWINGS

A detailed description of the preferred embodiment(s) is(are) provided herein below by way of example only and with reference to the following drawings, in which:

FIG. 1 is a system diagram of the present invention, in one particular embodiment thereof.

FIG. 2 is a flowchart illustrating the overall method of the present invention.

FIG. 3 is a flowchart illustrating a particular aspect of the method illustrated in FIG. 2, namely the method of identifying a user in accordance with the present invention.

FIG. 4 is a flowchart illustrating a particular aspect of the method illustrated in FIG. 2, namely the method of identifying an intended recipient in accordance with the present invention.

FIG. 5 is a flowchart illustrating a particular aspect of the method illustrated in FIG. 2, namely the method of recording a message and converting the message to an email in accordance with the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### SUMMARY OF INVENTION

The system of the present invention consists of a computer system enabling an email message to be sent from a communication device to a remote device by operation of an intermediary server computer based on voice input from the communication device. The intermediary server computer provides means for the user of the communication device to selectively determine by voice activation the recipient address of the email sent by the system.

In a more particular aspect of the present invention, the intermediary server computer is operable to transform the voice input into email content and include this email content in the email by either (1) attaching the voice input to the email, or (2) converting the voice input to text by operation of a speech to text engine.

In another aspect of the invention, the web server is further linked to a speech to text engine. In a still other aspect of the invention, the intermediary server computer is linked to means for training the speech to text engine for converting the voice input from a particular user to binary text. In yet another aspect of the present invention, the server application includes a matching utility as described below.

### DETAILED DESCRIPTION OF THE INVENTION

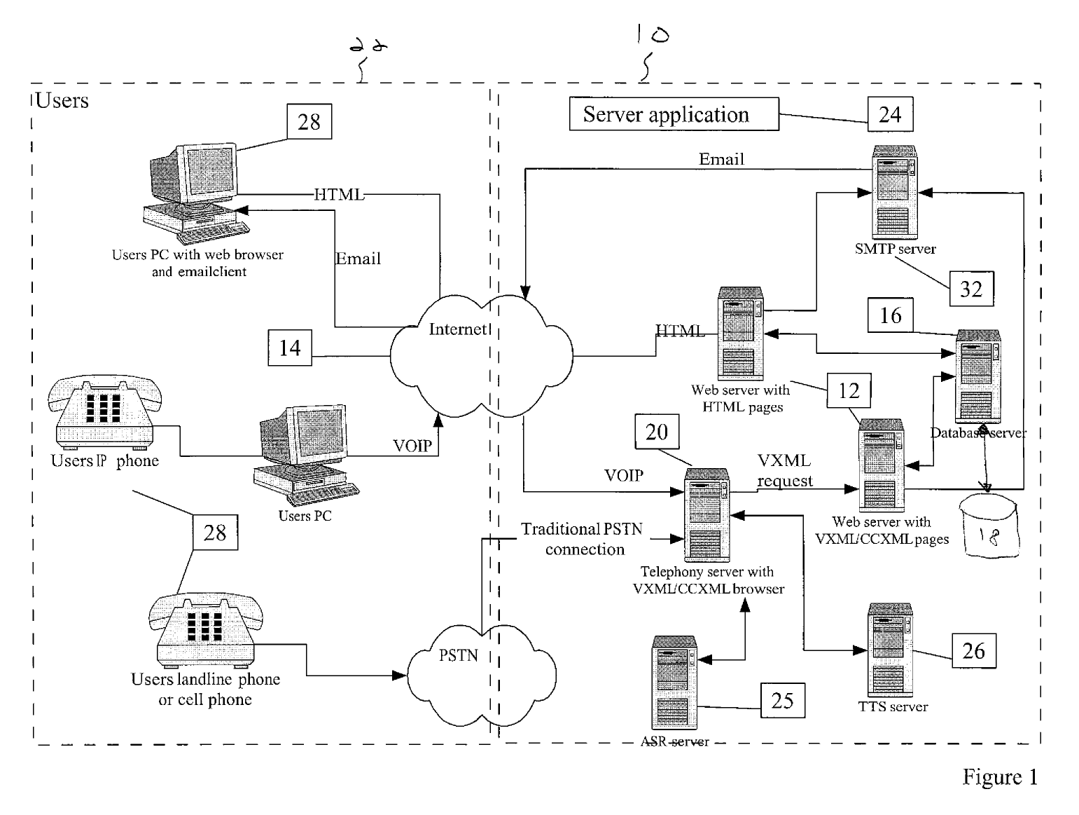

The system of the present invention is best understood by reference to FIG. 1. The system of the present invention is implemented on what is best understood as a server (10) (sometimes referred to as the intermediary server computer) which is a or group of interconnected servers, databases and associated utilities. The server (10) in one particular embodiment of the present invention includes: (a) one or morea web servers (12) connected to the Internet (14), and operable to provide a series of web pages (not shown) further described below; (b) a database server (16) linked to a database (18); and (c) a telephony utility. In a particular embodiment of the present invention, the telephony utility consists of a known telephony server (20) illustrated in FIG. 1 that enables interaction of the server (10) with at least one communication device (22) associated with a user. Specifically, the telephony server (20) provides a VXML/CCMXL browser that is operable to receive user inputs via a PSTN connection established by the communication device 22 calling a PSTN number associated with the telephony server (20).

In one embodiment a particular aspect of the present invention, the database server (16) is provided using a MS-SQL™ server.

In another embodiment particular aspect of the present invention, the communication device (22) consists of a VoIP phone 28, as illustrated in FIG. 1, in which case the telephony server (20) of the present invention is further operable to support a VoIP connection between the communication device (22) and the server (10).

The telephony server (20) is linked to the web server (12) or an additional web server (12) as specifically illustrated for exemplary purposes in FIG. 1. The web server (12) is operable to provide a plurality of VXML/CCMXL web pages which when loaded on the VXML/CCMXL browser, the system of present invention is operable to enable the user of the communication device (22) to interact with the server (10) via voice commands.

Each of the telephony server (20) and the web server (12) is linked to the database server (16) of the present invention.

A server application (24) is linked to the server (10) of the present invention. The server application (24) consists of one or more software utilities that enables the described processing steps and supports the described functions, in accordance with the present invention. The computer program of the present invention is therefore best understood as the server application (24) linked to server (10). It should be understood that one of the aspects of the present invention is that there is no requirement for any specific programming on the communication device (22).

The server (10) further includes a speech recognition utility (25). In accordance with one aspect of the present invention, the speech recognition utility (25) consists of a speech recognition server (or ASR server) as illustrated in FIG. 1. In a particular implementation of the present invention, the speech recognition server is linked to a NUANCE™ speech recognition engine (25).

The server (10) also includes a text to speech utility (26) that is operable to convert text to speech. In one particular aspect of the present invention, the text to speech utility (26) is interoperate with the database server (16) to retrieve specific text data and convert such text data to voice data. The voice data is then provided to the user of the communication device (22) via the telephony the server (20). In a particular implementation of the present invention, the text to speech utility (26) consists of a known TTS server that includes a REALSPEAK™ text-to-speech engine.

Suitable communication interfaces (not shown) are provided to the various components of server (10) in a manner that is well known to enable to those skilled in the art the various communications therebetween.

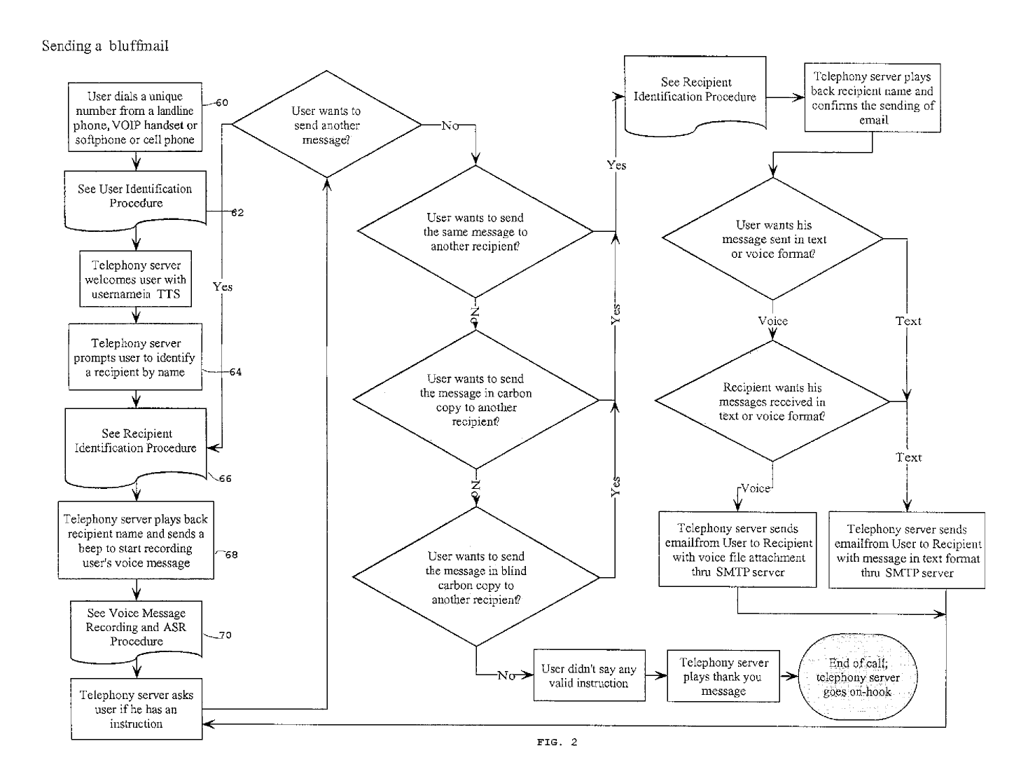

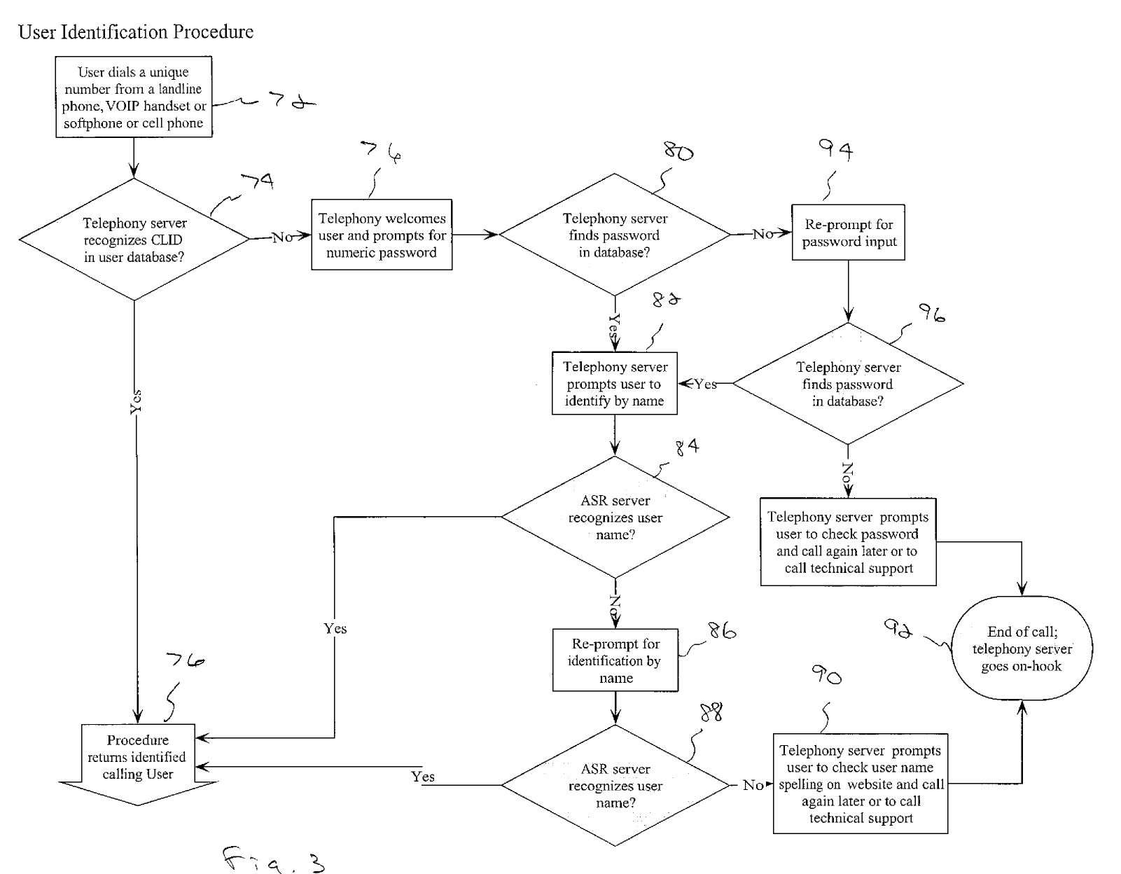

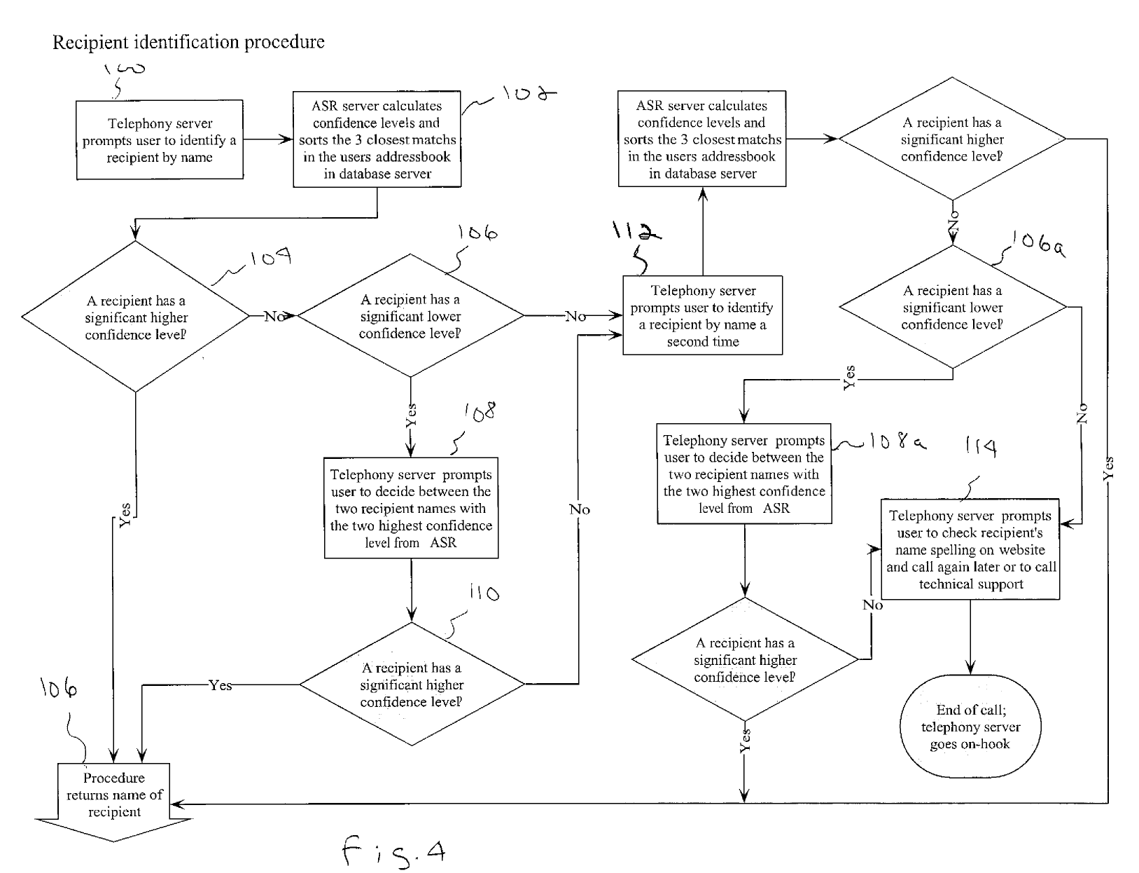

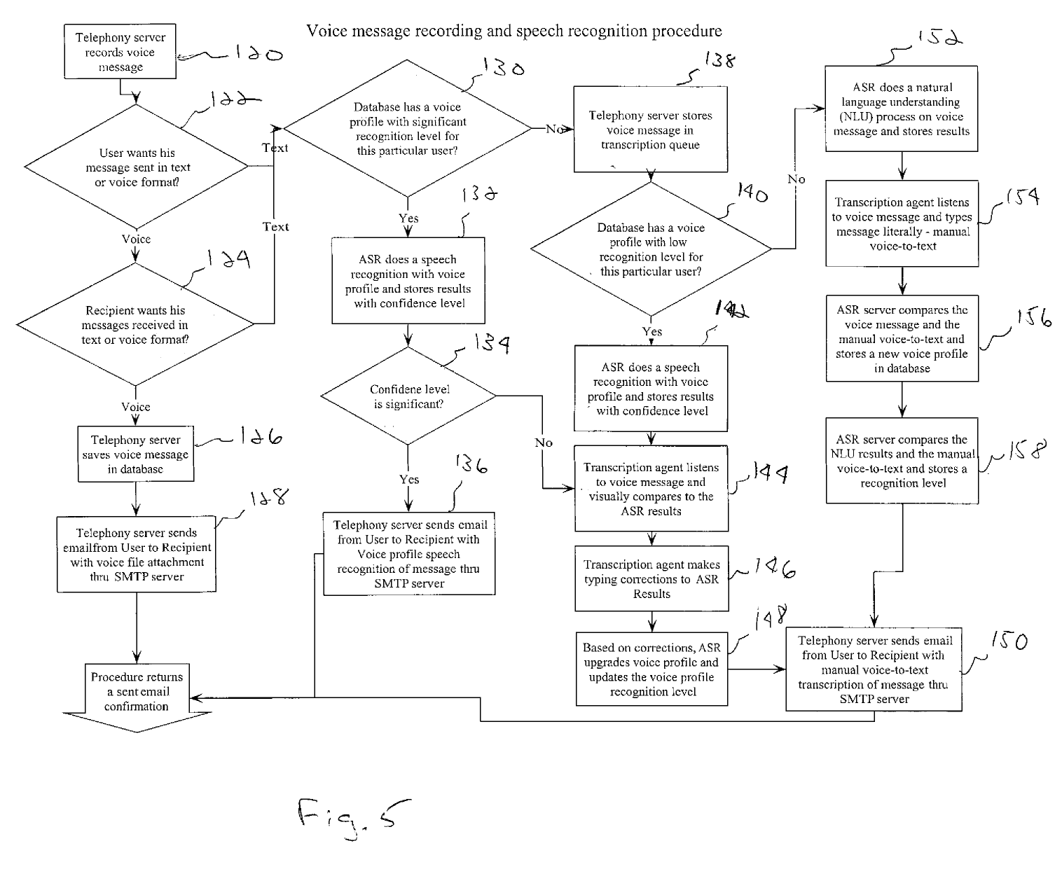

The overall method of the present invention is illustrated in FIG. 2. In summary, the method of the present invention consists of: (A) an authorized user placing a call to a number associated with the intermediary server computer (10) (and specifically the telephony server (20)), by operation of the telephony utility, act 60; (B) the intermediary server computer (10) authenticating the authorized user, act 62 (see also FIG. 3), and if authenticated provides a voice prompt to the authorized user to send an email by operation of the system, act (64); (C) the authorized user providing voice input associated with a particular entry from an address book stored to the database for the authorized user; (D) the intermediary server computer (10) matching the voice input with a particular entry in the address book based on a matching utility provided by the server application (24) act 66 and FIG. 4, and providing a voice prompt to the authorized user identifying the matched particular entry of the address book; (E) the intermediary server computer (10) providing a voice prompt to the authorized user to begin recording a voice message, act 68 and FIG. 5; and (F) the intermediary server computer creating an email message based on the voice message.

A user is first required to sign up to a website associated with the web server (12) and to perform certain set up functions related to the operation of the present invention. In a particular implementation of the present invention related set-up functions/routines are initiated from a personal computer (28) that communicates with the web server (12) via the Internet (30). In a particular aspect of the server application (24), an administration utility (not shown) is provided for administering the rights granted to a plurality of users who have completed the sign up process, such users being referred to as “authorized users” in this disclosure. As part of the sign up process, a unique identifier is associated with the authorized user that enables the web server (12) to authenticate the authorized user. In a particular aspect of the present invention this unique identifier includes the phone number associated with the authorized user's communication device which permits the user to automatically login to the server (10) without any prompts. It should be understood that alternate means for authentication are also contemplated by the present invention.

The administration utility of the present invention provides access to authorized users to certain functions linked to the server (10). In a particular implementation of the present invention, these functions/resources are accessed via a series of web pages linked to the web server (12). These web pages, for example, enable authorized users to create one or more address books in cooperation with the database server (16). Another function/resource associated with the server (10) is an import/export utility (not shown) that enables authorized users to import address books or selected portions thereof (including for example contact names, phone numbers, fax numbers, mobile numbers, email addresses and the like) to the address book provided on the database (18), and also to export an address book or selected portions thereof provided on the database (18) to an external address book (e.g. an address book that is part of an email application of an authorized user such as OUTLOOK™).

It should be understood that other functions/resources can be associated with the server (10) and made accessible via selection from possible options via voice commands by operation o of the matching utility described in the present invention.

The operation of the present invention is best understood by reference to the example below. Aspects of example below are further illustrated by reference to the Figures. Specifically: (A) FIG. 2 illustrates the overall method of the present invention, and operation of the computer program and system of the present invention; (B) FIG. 3 illustrates a particular aspect of the method of the present invention, and operation of the computer program and system of the present invention, namely identification of a user in accordance with the present invention; (C) FIG. 4 illustrates a particular aspect of the method of the present invention, and operation of the computer program and system of the present invention, namely identification of a identifying an intended recipient in accordance with the present invention; and (D) lastly FIG. 5 illustrates a particular aspect of the method of the present invention, and operation of the computer program and system of the present invention, in which a voice message recording is made and speech recognition is applied in accordance with the present invention.

### EXAMPLE IN OPERATION

1. Authorized user dials a unique number from a communication device (22), act (72) consisting of a landline phone, VoIP handset, softphone or cell phone. A caller ID or CLID is associated with the communication device (22).
   User Identification
2. (a) In one particular aspect of the present invention, if the telephony server (20) recognizes the CLID, act 74, then telephony server (20) welcomes the authorized user. In one particular implementation of the present invention, the database server (18) is operable to retrieve a username from the database (18) that is lined with the given CLID, which is converted to speech and communicated to the authorized user by operation of the text-to-speech server (26) and via the telephony server (20), act (76). The authorized user proceeds in this case to act 100, FIG. 4Step 3, as per below.
   (b) If the telephony server (20) does not recognize CLID, the telephony server (20) welcomes the user and prompts for a numeric password, act (78);
      (i) if the telephony server (20) is operable in co-operation with the database server (16) to find the password in the database (18), act (80), the telephony server (20) is operable to prompt the user to identify by name provided by voice input, act (82).
         (A) if the speech recognition utility (25) recognizes user's name and the database server (16) confirms that the user is an authorized user, act (84), the authorized user proceeds to Step 3 below
         (B) if the speech recognition utility (25) does not recognize the user's name, the speech recognition utility (25) re-prompts the user to identify its name by voice input, act (86). If the speech recognition utility (25) still does not recognize the user's name, act (88), the telephony server (20) is operable prompt the user to check his/her name's spelling on the website linked to the server (10) and to call again when the problem has been resolved, or to call technical support, act (90). The call is ended in this case, act (92).
      (ii) if the database server (16) does not find the given password in the database (18), act (80), the telephone server (20) re-prompts for input of the password, act (94);
         (A) if the database server (16) does not find password given by the user in database (18), act (96), the telephony server (20) prompts the user to check password and call again later or to call technical support, act (98) and call is ended, act (92);
         (B) if the database server (16) is operable to find the password in the database (18), the telephony server (20) prompts the user to identify by name, act (82);
            (I) if the speech recognition utility (25) does not recognize the given user name, act (84), the telephony server (20) it re-prompts for the user to provide identification by name, act (86); if the speech recognition utility (25) still does not recognize user name, the telephony server (20) prompts the user to check password and call again later or to call technical support and call is ended, acts 88 and 90;
            (II) if the speech recognition utility (25) recognizes name given by the user, and this name is found in the database (18) by operation of the database server (12), then the user proceeds to Step 3 below.
               Recipient Identification
3. The telephony server (20) is operable to prompts the authorized user to identify a recipient by a name provided by voice input. The server application (24) includes a matching utility (not shown). In one particular implementation of the present invention, the matching utility is best understood as a function of the database server (16), whereby the database server (16) is operable to dynamically search relevant entries in the address book for the authorized user for a match with the voice input provided by the authorized user for the purpose of identifying the intended recipient of an email. Specifically, the matching utility on the server (10) is operable to calculate statistical confidence levels as percentages based on the voice input in relation to each of the relevant entries in the address book. In a particular implementation of the present invention, the voice input is transferred to the speech recognition utility (25) which based on a dynamic statistical model is operable to provide a percentage of confidence of correspondence between the voice input and each entry of a specified address book, act 102. The matching utility is further operable on the server (10) to sort the confidence levels calculated to establish a predetermined number of the closest matches between the voice input and the relevant address book, as determined by the by the calculated confidence levels. Where the relevant entry is the name of a recipient for which an email is intended, if a recipient has a significantly higher confidence level, act 104, the telephony server (20) is operable to play back the selected recipient name, act 106, and to communicate a “beep” to start recording user's voice message. In a particular implementation of the present invention, if a particular recipient is identified as a possible match but this recipient has a significantly lower confidence level, act 106, as per the calculation of the matching utility on the server (10) the telephony server (20) is operable to prompt the user to decide between the two recipient names with the two highest confidence levels as established by operation of the matching utility on the server (22), act 108. If a particular recipient identified by the matching utility has a significantly higher confidence level, act 110, the telephony server (20) plays back recipient name and sends a beep to start recording user's voice message. If a particular recipient identified by the matching utility on the server (10) does not have a significantly higher confidence level, the telephony server (20) prompts the authorized user to identify a recipient by name a second time, act 112, after which the process as per above beings again.

If again no recipient is matched in association with a significantly higher confidence level, the telephony server (20) prompts the authorized user to check the spelling of the recipient's name on the website and call again later or call technical support, act 114 and call is ended.

Message Recording

4. After establishing the identity of a recipient for an email, and the telephony server (20) beeping the communication device (22), the telephony server (20) is operable to record voice message provided by the authorized user, act 120, FIG. 5. In this a particular embodiment of the present invention, the telephony server (20) is operable to inquire whether the authorized user wants the voice message sent in text or voice format as an email, act 122. If the authorized user wants his/her voice message sent in voice format and the receiver wants his messages received in voice format, act 124, the telephony server (20) stores the voice message in the database (18), act 126, and the server (10) is operable to construct an email that includes the voice message as a voice file attachment in one or more known file formats and to send the email via the SMTP server (32) that is part of the server (10), act 128. In a particular implementation of the present invention, the telephony server (20) then prompts the authorized user whether s/he wishes to send another message. If authorized user wants to send another message, return to Step 3 above;

If the authorized user indicated the telephony server (20) that s/he wishes to send his/her message in text, act 122, the server (10) is operable to determine whether a voice profile with a significant recognition level exists for the authorized user on the database (18), act 130. It should be understood that every person has a different way of pronouncing words. A speech recognition engine needs a user voice profile to understand natural language sounded by a particular authorized user. The system of the present invention uses different voice messages to train the system and create: (1) a voice profile and 2) a voice signature for each authorized user. If database (18) has a voice profile with significant recognition level, act 132, the speech recognition utility (25) is operable perform speech recognition based on the voice profile and store the results of the speech-to-text conversion with the applicable confidence level to the database (18). If the confidence level is statistically significant, act 134, the telephony server (20) sends the email from the authorized user to the recipient via the SMTP server (32), act 136.

Telephony server (20) is operable to prompts the authorized user as to whether s/he wants to send another message. If the authorized user wishes to send another message, s/he returns to Step 3 above. If the authorized user does not want to send another message, then telephony server (20) plays a thank you message and the call is ended.

If database (18) does not have a voice profile with significant recognition level for the authorized user, the telephony server (20) is co-operates with the database server (16) to store the voice message provided by the authorized user into the database (18) and specifically into a transcription queue provided on the database (18), act 138. If the database (18) has a voice profile with low recognition level for this particular user, act 140, the speech recognition utility (25) performs a speech recognition routine and stores the results thereof along with the associated confidence level to the database (18), act 142.

The server application (24) provides means for a transcription agent to access transcription queue on the database (18) and specifically: (i) the voice message, and (ii) a text version. The transcription agent compares (i) and (ii), act 144 and makes necessary corrections via a word processing utility provided by the server application (24) to the transcription agent, act 146. The server application (24) is operable to upgrade the voice profile for the authorized user on the database (18) based on the corrections, act 148. This upgrading of the voice profile can occurs through a plurality of iterations. The involvement of the transcription agent is transparent to the authorized user.

The server (10) is operable to send a email that includes a speech-to-text conversion of the voice message provided by the authorized user, by operation of the SMTP server (32), act 150.

The telephony server (20) prompts/asks the authorized user if s/he wants to send another message. If the authorized user wants to send another message, the authorized user returns to Step 3 above. If the authorized user does not want to send another message, the telephony server (20) plays a thank you message and call is ended.

If the confidence level is significant, the telephony server (20) sends an email on behalf of the authorized user to the recipient incorporating the text version of the voice message, such email being sent via the SMTP server (32). The telephony server (20) is then operable to prompt/ask the authorized user if s/he wants to send another message. If s/he wants to send another message, the authorized user returns to Step 3 above. If the authorized user does not want to send another message, the telephony server (20) is operable to play a thank you message and then the call is ended.

If the database (18) does not include a voice profile for the authorized user, even if with a low recognition level for this particular user, the speech recognition utility (25) of the present invention is operable to apply a natural language understanding (NLU) process on the voice message and store the results thereof, act 152. The voice message and NLU results are stored to the database (18) as part of the transcription queue. The transcription agent then accesses the server in order to listen to the voice message and to types the message literally to a word processing utility provided by the server (20), act 154. The speech recognition utility (25) is operable to compare the voice message and the manually generated voice-to-text version and derive, based on the foregoing, a new voice profile for the authorized user, which is stored to the database (18). The speech recognition utility (25) is also operable to compare the NLU results and the manually generated voice-to-text version and store recognition level obtained based on such comparison, act 158.

The telephony server (20) is operable to send an email from the authorized user to the intended recipient with manual voice-to-text transcription of the message, via the SMTP server (32), act 150.

The telephony server (20) prompts/asks the authorized user if s/he wants to send another message. If the authorized user wishes to send another message, the authorized user returns to Step 3 above. If the authorized user does not want to send another message, the telephony server (20) plays thank you message and call is ended.

In another particular aspect of the present invention, that database server (16) and the database (18) cooperate to provide a relational database such that an update by a particular user of their contact information on the database can be used to update the address book of other authorized users who have included the contact information for the particular user in their address book. A user has an address book with 2 sections: 1) external contacts and 2) other users of the system. Each user can add and modify external contacts and their related information (phone numbers, email addresses). A user cannot modify his system users, they are only names; users modify themselves their personal information (phone numbers, email addresses, public or confidential information, filters, auto-responses, and preferences). When a user changes his email address, address changes for every other user without them knowing about it. A user only needs a name to send an email to another user. When an external contact subscribes to the system, s/he is removed from external contacts sections in every user where s/he is present and added in the user contacts section and takes control over his personal information.

Other variations are possible. Other utilities can be used to provide the functionality described herein, including for example alternate text to speech or speech to text technologies.

The present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A method of sending a message from a voice operated communication device, the method comprising the acts of:
receiving at the least user voice information;
identifying a registered user;
receiving message recipient identification information in the form of user voice information;
responsive to said received recipient identification information, identifying a message recipient;
responsive to identifying said message recipient, determining if said user wants said identified message recipient to receive a message and a voice format or a text format;
in response to said determination that said user wants said identified message recipient to receive a message in a voice format, performing the acts of:
receiving a voice message from said user, said voice message intended for said identified message recipient;
storing said voice message as a voice file in a database; and
sending and e-mail to said identified message recipient with said voice file as an attachment for playback by said identified message recipient; and
in response to said determination that said user wants said identified message recipient to receive a message in a text format, performing the acts of:
receiving a voice message from said user, said voice message intended for said identified message recipient;
performing speech recognition on said voice message, for generating a text message corresponding to said voice message; and
sending and e-mail to said identified message recipient, said email and including said text message corresponding to said voice message.

2. The method of claim 1, wherein said text message is sent as an attachment to said email to said identified message recipient.

3. The method of claim 2, wherein said text message is sent as embedded text with said email to said identified message recipient.

4. The method of claim 1, wherein said received at least user voice information includes information from a user communication device, for identifying said user.

5. The method of claim 4, wherein said information from a user communication device includes information identifying a specific user communication device.

6. The method of claim 5, wherein said information identifying a specific user communication device includes an identification number associated with said specific user communication device.

7. The method of claim 6, wherein said identification number associated with said specific user communication device includes a telephone number associated with said specific user communication device.

8. The method of claim 4, wherein said information from a user communication device includes information identifying a specific user communication device communication circuit.

9. The method of claim 8, wherein said specific user communication device communication circuit includes a telephone number associated with said communication circuit.

10. The method of claim 1, wherein said act of performing speech recognition on said voice message, for generating a text message corresponding to said voice message, comprises the acts of:
obtaining a voice profile for speech from said specific, identified registered user;
performing speech recognition on said voice message based on said identified registered user voice profile;
in response to performing speech recognition on said voice message, determining a confidence level that said speech recognition is accurate;
in response to a determination that said confidence level is significant, sending and e-mail from said user to said recipient with said text file; and
in response to a determination that said confidence level is not significant, performing the acts of:
providing a transcription agent to listen to the voice message and visually compare the listened to voice message with the transcribed message;
in response to said transcription agent listening to the voice message and visually comparing the listened to voice message with the transcribed message, making corrections to said transcribed message;
in response to said corrections to said transcribed message, updating said user voice profile; and
sending and e-mail from said user to said recipient with said corrected transcribed message as a text message.
